(19) United States
(12) Patent Application Publication
(10) Pub. No.: US 2026/0106405 A1
(43) Pub. Date: Apr. 16, 2026

(54) CONNECTOR HOUSING, CONNECTOR ASSEMBLY, AND ASSEMBLY METHOD

(71) Applicant: Tyco Electronics (Shanghai) Co., Ltd., Shanghai (CN)

(72) Inventors: Wenfang (Felix) Zhang, Shanghai (CN); Tongbao (Tim) Ding, Shanghai (CN); Yongjian (Justin) Huang, Shanghai (CN); Chunjie Hu, Shanghai (CN); Zhimin Zhang, Shanghai (CN); Dan (Nico) Li, Shanghai (CN)

(73) Assignee: Tyco Electronics (Shanghai) Co., Ltd., Shanghai (CN)

(21) Appl. No.: 19/359,835

(22) Filed: Oct. 16, 2025

(30) Foreign Application Priority Data
Oct. 16, 2024 (CN) 202411449496.0

(51) Int. Cl. H01R 13/627; H01R 43/26

(52) U.S. Cl. CPC H01R 13/6278; H01R 43/26

(57) ABSTRACT

A connector housing includes a main body and a fixing element on the main body. The main body includes one or more cavities. One or more openings are provided on one surface of the one or more cavities. The main body has the one or more openings. The fixing element includes a top plate, two side plates, one or more inserting plates, and a connecting element. The two side plates are each bent from the top plate and extend toward two opposite sides of the main body. The one or more inserting plates are bent from the top plate and extend toward the main body. Each inserting plate is inserted into one of the one or more openings when the fixing element receives a certain force. The connecting element, broken when the fixing element receives the certain force, is between the two side plates and the main body.

### CROSS-REFERENCE TO RELATED APPLICATIONS

This application claims the benefit of the filing date under 35 U.S.C. § 119(a)-(d) of Chinese Patent Application No. 202411449496.0, filed on Oct. 16, 2024.

### FIELD OF THE INVENTION

The present disclosure relates to the technical field of electrical connection and, more particularly, to a connector housing, a connector assembly, and an assembly method.

### BACKGROUND OF THE INVENTION

A connector assembly used to achieve electrical connections typically includes a connector housing and a conductive terminal. The conductive terminal is used for connecting an external cable. The connector housing is used for accommodating the connection terminal. The connector housing includes a base and a fixing element. After the conductive terminal is inserted into the base, the fixing element may be mounted on the base to fix the conductive terminal.

Generally, the base and the fixing element of the connector housing are separately arranged, so two sets of molds are required to manufacture the connector housing. In addition, the structure of the connector housing is not conducive to industrial automated assembly.

### SUMMARY OF THE INVENTION

A connector housing includes a main body and a fixing element on one side of the main body. The main body includes one or more cavities. One or more openings are provided on one surface of the one or more cavities. The one side of the main body has the one or more openings. The fixing element includes a top plate, two side plates, one or more inserting plates, and a connecting element. The two side plates are each bent from the top plate and extend toward two opposite sides of the main body. The one or more inserting plates are bent from the top plate and extend toward the main body. Each inserting plate is inserted into one of the one or more openings when the fixing element receives a certain force. The connecting element, broken when the fixing element receives the certain force, is between the two side plates and the main body.

### BRIEF DESCRIPTION OF DRAWINGS

The invention will now be described by way of example with reference to the accompanying figures, of which:

FIG. 1 is a perspective view of a connector assembly according to an embodiment;

FIG. 2a is a perspective view of a connector housing according to an embodiment, including a partially enlarged perspective view of a fixing element;

FIG. 2b is another perspective view of the connector of FIG. 2a;

FIG. 2c is a rear view of the connector housing of FIG. 2a;

FIG. 2d is a right side view of the connector housing of FIG. 2a;

FIG. 2e is a bottom view of the connector housing of FIG. 2a;

FIG. 3 is a perspective view of a connector housing according to another embodiment;

FIG. 4a is a perspective view of another connector assembly having the connector housing of FIG. 2a and a conductive terminal prior to assembly according to an embodiment;

FIG. 4b is perspective view of the connector assembly of FIG. 4a, with the conductive terminal of FIG. 4a inserted into the connector housing of FIG. 2a;

FIG. 4c is a perspective view of the connector assembly of FIG. 4a, with a fixing element of the connector housing of FIG. 2a being broken, and including a partially enlarged perspective view of the fixing element;

FIG. 4d is a perspective view of the fixing element of FIG. 4c being inserted into a main body of the connector housing of FIG. 4a;

FIG. 4e is a perspective view of the connector assembly of FIG. 4a in an assembled state, and including a partially enlarged schematic diagram L cut along line AA;

FIG. 4f is a section view of FIG. 4e cut along line BB of FIG. 4e, and including a partially enlarged perspective view of a locking mechanism; and

FIG. 5 is a flowchart of an assembly method of assembling a connector assembly according to an embodiment.

### DETAILED DESCRIPTION

The following detailed description of embodiments of the present invention will refer to the accompanying drawings, which form part of this disclosure. The accompanying drawings show, by way of illustration, specific embodiments. The embodiments are not intended to limit the scope of all embodiments of the present disclosure. In the specification, the same or similar reference signs indicate the same or similar components. It is to be understood that other embodiments may be utilized and structural modifications may be made without departing from the scope of the present disclosure. The following detailed description, therefore, is not restrictive, and the scope of the present disclosure is defined by the appended claims.

The terms “including”, “comprising” and similar terms used herein should be understood as open terms, that is, “including/comprising but not limited to” meaning that other contents may also be included. The term “one example” means “at least one example”. The term “another example” means “at least one additional example”, etc.

It should be understood that the embodiments discussed herein are merely illustrative of ways to make and use the disclosure, and do not limit the scope of the disclosure. Expressions such as upper, lower, left, right, top, and bottom used in describing the components are not absolute, but relative. When the components are arranged as shown in the figures, these expressions are appropriate, but when the positions of the components in the figures are changed, these expressions are changed accordingly.

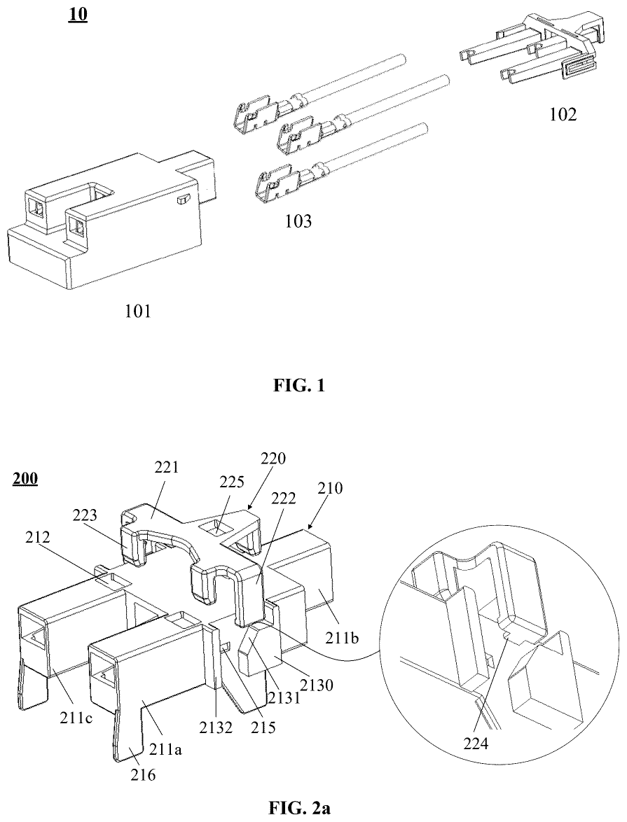

An exemplary embodiment of a connector assembly 10 will now be described with reference to FIG. 1. The connector assembly 10 may be used in refrigeration applications, such as compressors. As shown in FIG. 1, the connector assembly 10 includes a main body base 101, a fixing element 102, and conductive terminals 103 connected with cables. After the conductive terminals 103 are inserted into a cavity of the main body base 101, the fixing element 102 is inserted into the main body base 101 along an insertion direction of the conductive terminals 103. The fixing element 102 fixes the conductive terminals 103. As shown in FIG. 1, the main body base 101 may accommodate three cables, and the three cavities of the main body base 101 for accommodating the three cables are staggered. Holes corresponding to the cavities may be provided at a bottom of the main body base 101 for the insertion of a terminal post of the compressor.

The main body base 101 and the fixing element 102 may be made of plastic. As shown in FIG. 1, the main body base 101 and the fixing element 102 are independent components, so two sets of molds are required for their separate production. In addition, the fixing element 102 is inserted into the main body base 101 from behind the conductive terminal 103, which is not conducive to automated installation of the connector.

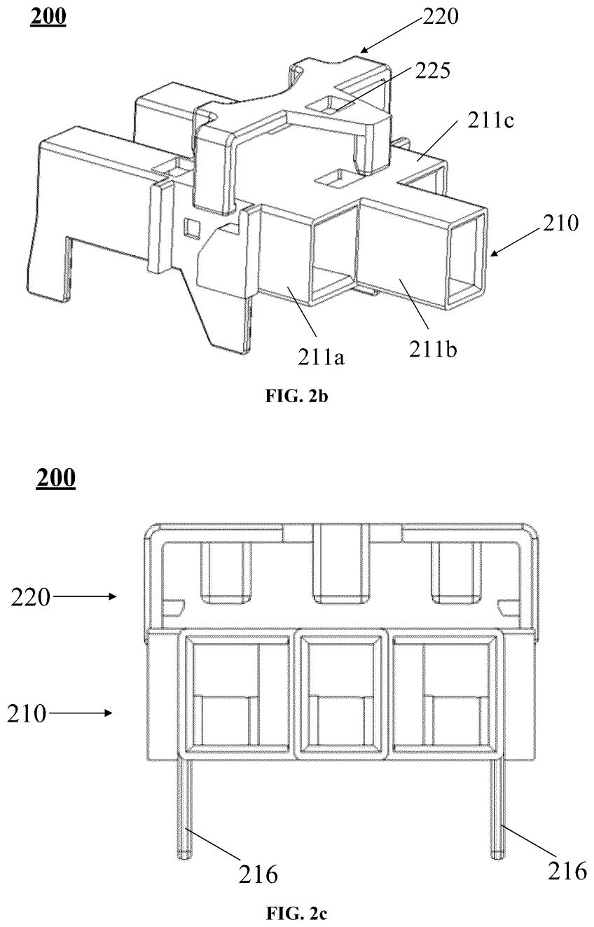

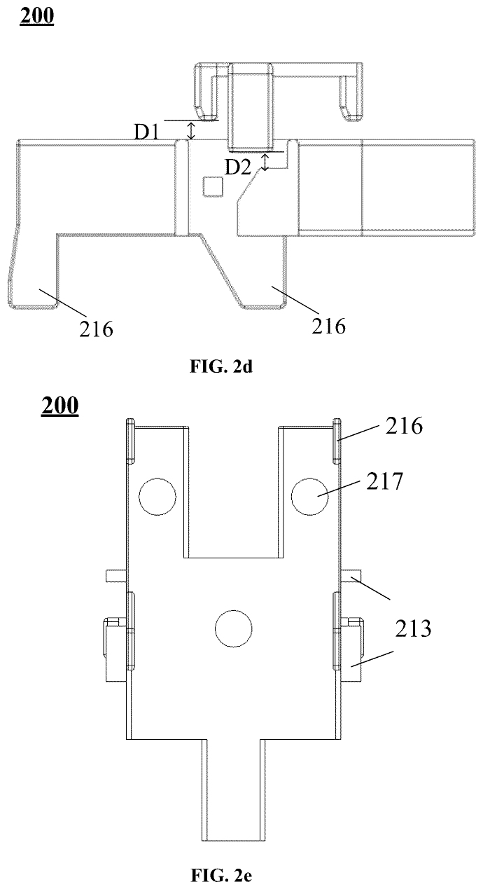

An exemplary embodiment of a connector housing 200 will now be described with reference to FIGS. 2a-2e. As shown in FIGS. 2a-2c, the connector housing 200 includes a main body 210 and a fixing element 220. The main body 210 includes one or more cavities 211a, 211b,211c, as shown in FIGS. 2a-2b, which are respectively used to accommodate one or more conductive terminals 230. The number of cavities 211a,211b,211c depends on the layout of the device mated with the connector housing 200, such as the number of the terminal post of the compressor. As shown in FIGS. 2a-2b, the main body 210 includes three cavities 211a,211b,211c into which three conductive terminals 230 may be inserted. In other embodiments, the number of cavities in the main body 210 may vary, such as 1, 2, or more than 3. Additionally, the layout of the cavities 211a,211b,211c depends on the layout of the device mated with the connector housing 200, such as the location of the terminal post of the compressor. As shown in FIGS. 2a-2b, the cavity 211b and the two adjacent cavities 211a and 211c are staggered. In other embodiments, the cavities 211a,211b,211c may be disposed of in other ways, such as in parallel with one another.

Each cavity 211a,211b,211c includes multiple surfaces, one of which is provided with an opening 212. The number of openings 212 corresponds to the number of cavities 211a,211b,211c.

As shown in FIGS. 2a-2b, the fixing element 220 is located near a side of the main body 210 that has the openings 212. The fixing element 220, as shown in FIG. 2a, is a rack structure, including a top plate 221, two side plates 222, and one or more inserting plates 223. The number of the inserting plates 223 corresponds to the number of the cavities 211a,211b,211c.

As shown in FIGS. 2a-2b, the top plate 221, is spaced apart from a top surface, i.e., the surface provided with openings 212, of the main body 210. Both the side plates 222 and the inserting plates 223 are bent downward from the top plate 221. Specifically, the two side plates 222 are bent from the top plate 221 and extend downward to the left side and right side of the main body 210. The inserting plates 223 extend from the top plate 221 and toward the main body 210 below the top plate 221. The inserting plates 223 are configured to be inserted into the openings 212 of the main body 210 when the fixing element 220 receives a certain force.

The fixing element 220 further includes a connecting element 224, as shown in FIG. 2a, located between the side plate 222 and the main body 210. As shown in the partial enlarged schematic diagram in FIG. 2a, the connecting element 224 is located between the bottom of the side plate 222 and the side surface of the main body 210. The connecting element 224 is configured to detachably connect the main body 210 and the fixing element 220. In an initial state, the connecting element 224 forms a connecting bridge between the main body 210 and the bottom of the side plate 222 of the fixing element 220 to support the fixing element 220. The connecting element 224 may be broken, for example, when the fixing element 220 receives a downward force. In this case, the connecting element 224 cannot provide support, causing the fixing element 220 to move downward, thereby allowing the inserting plates 223 to be inserted into the openings 212.

The detachable connection provided by the connecting element 224 may be achieved by adjusting the size of the connecting element 224. For example, as shown in FIG. 2a, the width of the connecting element 224 is less than the width of the side plate 222. In addition, the connecting element 224 is small in other dimensions, such as height and length, which are in the order of mm. In this way, when the fixing element 220 is pressed, the connecting element 224 may be broken, causing it to be unable to support the fixing element 220, thereby allowing the fixing element 220 to move downward and the inserting plates 223 to be inserted into the openings 212 of the main body 210. In some embodiments, the magnitude of the force applied to the fixing element 220 may be 40 N.

In the connector housing 200, the main body 210 is provided for inserting conductive terminals 230, and the fixing element 220 is provided for fixing the conductive terminals 230. In addition, in the initial state, the detachable connecting element 224 connects the main body 210 and the fixing element 220, resulting in the main body 210 and the fixing element 220 being structurally integrated. Therefore, only one set of mold is required to manufacture the connector housing 200, thereby simplifying the preparation process. When the fixing element 220 receives a certain force, the connecting element 224 breaks and the fixing element 220 is inserted into the main body 210. In addition, since the fixing element 220 is located on the top of the main body 210, and the cavity 211a,211b,211c for inserting the terminals 230 are located on the front and rear sides of the main body 210, the insertion process of the conductive terminals 230 and the insertion process of the fixing element 220 do not interfere with each other. This facilitates automated assembly of a connector assembly 20.

In some embodiments, the connector housing 200 may be made of plastic, for example, by injection molding, i.e., by molding in one piece. As shown in FIG. 2a, the inserting plate 223 of the fixing element 220 is not positioned directly above the opening 212. In other words, at the top of the main body 210, the inserting plate 223 is offset from the opening 212, which facilitates the removal of the molded connector housing 200 from the mold. In this way, after the conductive terminals 230 are inserted into the cavity 211a,211b,211c of the main body 210, the fixing element 220 can be pushed into the openings 212 under the force in both downward and forward directions. In some embodiments, each inserting plate 223 is offset from the respective opening 212 by an equal distance. In this way, when applying force to the fixing element 220 by a manipulator, the fixed distance between the inserting plate 223 and the opening 212 enables precise operation.

In addition, as shown in FIG. 2a, the top plate 221 may be provided with a through hole 225. The position of the through hole 225 is opposite the position of the opening 212 on the second cavity 211b. The arrangement of the through hole 225 helps remove the mold of the connector housing 200.

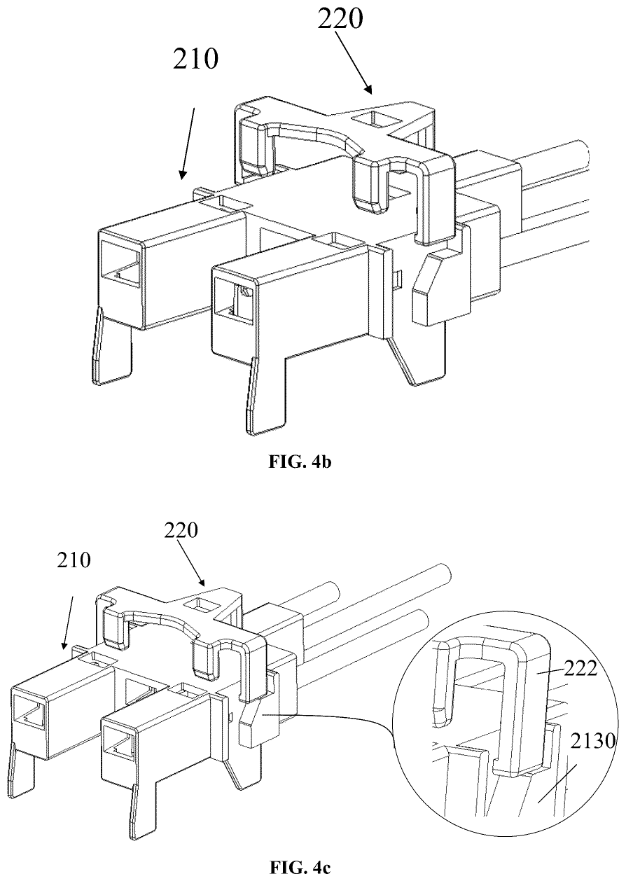

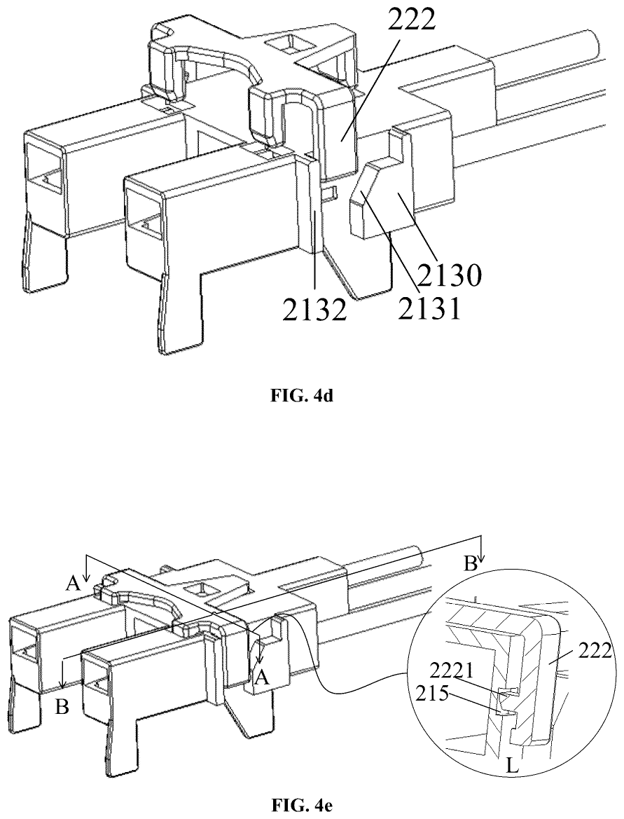

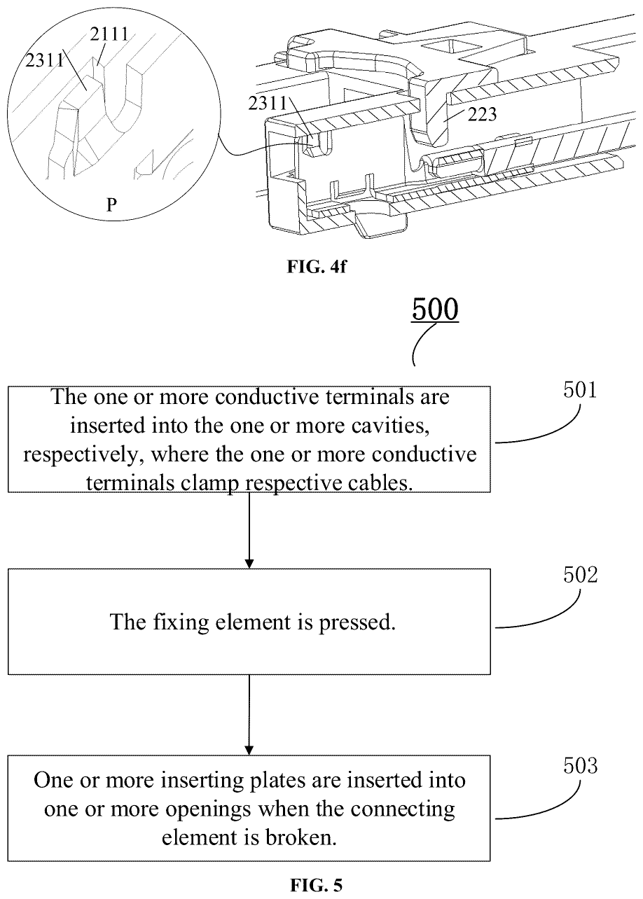

In some embodiments, two opposite sides of the main body 210 may be provided with guiding portions 213 for guiding the side plates 222 to move to help the inserting plates 223 to be inserted into the corresponding openings 212. The guiding portions 213 are, for example, guiding portions 213 disposed on opposite sides of the main body 210 of the connector housing 200. As shown in FIGS. 2a and 4d, each of the guiding portions 213 includes a support block 2130, and the support block 2130 and the side plate 222 are spaced apart. In the initial state, the bottom of the side plate 222 is not in contact with the top platform of the support block 2130. When the fixing element 220 receives a downward force, the connecting element 224 would be broken, causing the fixing element 220 to descend and the bottom of the side plate 222 to fall onto the top platform of the support block 2130.

In addition, in the initial state, the bottom of the inserting plate 223 is not in contact with the upper surface of the cavity 211a,211b,211c. As shown in FIG. 2d, a distance D1 between the bottom of the inserting plate 223 and the upper surface of the cavity 211a,211b,211c is greater than a distance D2 between the bottom of the side plate 222 and the top platform of the support block 2130. For example, D1 is 2 mm, and D2 is 1.7 mm. In this way, when the fixing element 220 falls onto the top platform of the support block 2130, there is a gap between the bottom of the inserting plate 223 and the upper surface of the cavity 211a,211b,211c to facilitate the horizontal movement of the fixing element 220.

In some embodiments, a ramp 2131, as shown in FIGS. 2a and 4d, is provided at the junction of the top and the front side of the support block 2130. After the conductive terminals 230 are inserted into the main body 210, the fixing element 220 in the initial state will be inserted into the main body 210 to fix the conductive terminals 230 when the fixing element 220 receives a forward and downward force. The ramp 2131 helps guide the movement of the fixing element 220. As shown in FIGS. 2a and 4d, the ramp 2131 is planar. It may be understood that, in some other embodiments, the ramp 2131 may have another shape, for example, a curved corner or a rounded corner.

In some embodiments, each of the guiding portions 213 include a blocking block 2132 for blocking excessive movement of the side plate 222 in the forward direction and guiding the side plate 222 to move downward. As shown in FIG. 2a, the blocking block 2132 is a strip-shaped block. When the fixing element 220 receives a forward force and the inserting plate 223 has moved to above the opening 212, the blocking block 2132 may block the side plate 222 from continuing to move forward. In addition, the long strip of the blocking block 2132 spans the side surface of the main body 210, which can guide the side plate 222 to move downward. In addition, as shown in FIG. 2a, the blocking block 2132 and the support block 2130 are disposed opposite to each other, forming a passage between them that allows the side plate 222 to move downward.

In some embodiments, the side surface of the main body 210 is provided with a concave portion 215, as shown in FIG. 2a, while the inner side of the side plate 222 includes a convex portion 2221, as shown in FIG. 4e. The concave portion 215 and the convex portion 2221 are used cooperatively. The convex portion 2221 may be inserted into the concave portion 215 after the inserting plate 223 is inserted into the opening 212. The combination of the concave portion 215 and the convex portion 2221 may increase the connection stability between the fixing element 220 and the main body 210.

In some embodiments, the bottom of the main body 210 includes multiple separating elements 216 extending downward. As shown in FIGS. 2a and 2c-2e, the separating elements 216 are sheet-like and serve to separate the connector housing 200 from an external device. For example, the bottom of the main body 210 is provided with four separating elements 216 extending downward from the left and right sides of the main body 210.

After the connector housing 200 is connected to the conductive terminals 230, the resulting connector assembly 20 may be connected to the terminal post of the compressor. In some embodiments, the bottom of each cavity 211a,211b,211c is provided with a socket 217, and the socket 217 is located adjacent to an insertion position of each conductive terminal 230. For example, as shown in FIG. 2e, the bottom of each of the three cavities 211a,211b,211c is provided with a socket 217. The socket 217 is used for the external device, such as the terminal post of the compressor, to be inserted into the conductive terminals 230. In addition, as shown in FIG. 2e, the separating element 216 is disposed around the socket 217. After the terminal post is inserted into the socket 217, the separating element 216 may separate the disc base of the terminal post from the connector housing 200.

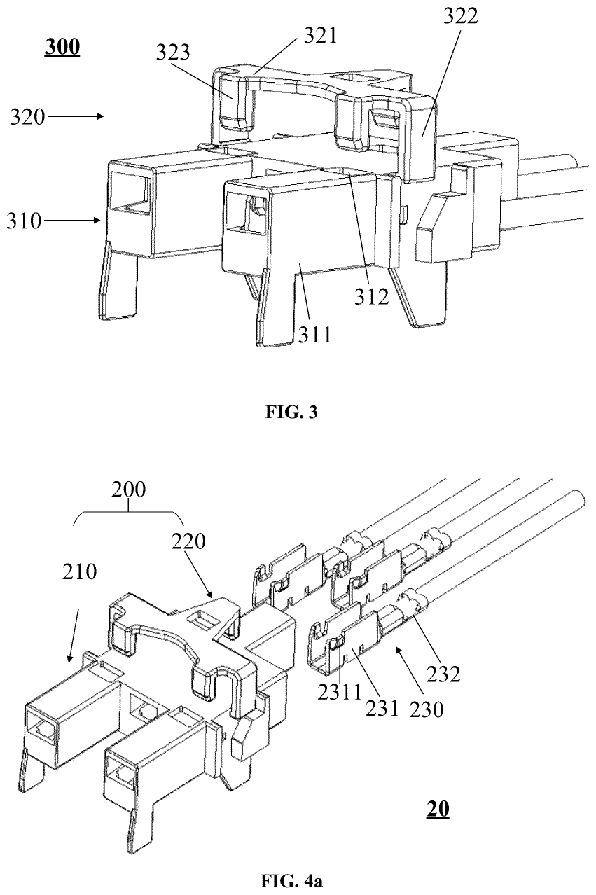

An exemplary embodiment of a connector housing 300 will now be described with reference to FIG. 3. The connector housing 300 differs from the connector housing 200 in the relative positions of the fixing element 320 and the main body 310 as compared to the fixing element 220 and the main body 210. As shown in FIG. 3, the inserting plate 323 of the fixing element 320 may be directly above the opening 312.

As shown in FIG. 3, the connector housing 300 includes the main body 310 and the fixing element 320. The main body 310 includes one or more cavities 311, which are respectively used to accommodate one or more conductive terminals. One surface of the cavity 311 is provided with an opening 312. The number of openings 312 corresponds to the number of cavities 311. The fixing element 320 is located on a side of the main body 310 that has the openings 312. The fixing element 320 is a rack structure, including a top plate 321, two side plates 322, and one or more inserting plates 323. The number of the inserting plates 323 corresponds to the number of the cavities 311. The top plate 321 is spaced apart from a top surface, i.e., the surface provided with openings 312, of the main body 310. Both the side plates 322 and the inserting plates 323 are bent downward from the top plate 321. Specifically, the two side plates 322 are bent from the top plate 321 and extend downward to the left and right sides of the main body 310. The inserting plates 323 extend from the top plate 321 and toward the main body 310 below the top plate 321. The inserting plate 323 is disposed opposite the corresponding opening 312, that is, the inserting plate 323 is located directly above the opening 312. The inserting plates 323 are configured to be inserted into the openings 312 of the main body 310 when the fixing element 320 receives a certain force. The fixing element 320 further includes a detachable connecting element located between the end of the side plate 322 and the main body 310.

In an initial state, the connecting element of the fixing element 320 forms a connecting bridge between the main body 310 and the bottom of the side plate 322 of the fixing element 320 to support the fixing element 320. The connecting element may be broken, for example, when the fixing element 320 receives a downward force. In this case, the connecting element cannot provide support, causing the fixing element 320 to directly move downward, thereby allowing the inserting plates 323 to be inserted into the openings 312.

In some embodiments, the integrally formed connector housing 300 may be obtained by a 3D printing process. In the connector housing 300, the fixing element 320 is located above the top of the main body 310, and the inserting plate 323 of the main body 310 is disposed opposite the opening 312. In this way, after the conductive terminal is inserted into the cavity 311 of the main body 310, the fixing element 320 can be pushed into the openings 312 under the force only in the downward direction.

An exemplary embodiment of the connector assembly 20 will now be described with reference to FIGS. 4a-4f. As shown in FIG. 4a, the connector assembly 20 includes the connector housing 200 and the conductive terminals 230. FIG. 4a shows conductive terminals 230 clamping cables before assembly. Each of the conductive terminals 230 includes an inserting portion 231 and a cable connecting portion 232. The inserting portion 231 may be inserted into and connected to the cavity 211a,211b,211c of the main body 210. The cable connecting portion 232 is configured to clamp a cable. The main body 210 includes three cavities 211a,211b,211c each for inserting one of three conductive terminals 230 in total.

As shown in FIG. 4b, all three conductive terminals 230 are inserted into the connector housing 200. The connector housing 200, as shown in FIGS. 4a-4b, are both in an initial state.

The fixing element 220, as shown in FIG. 4c, receives downward force, and the connecting element 224 is broken, causing the side plate 222 to move downward and to fall onto the top platform of the support block 2130. As shown in FIG. 4d, the fixing element 220 receives a forward force and moves into the passage formed by the blocking block 2132 and the support block 2130. The ramp 2131 on the support block 2130 may guide the side plate 222 into the passage, thereby improving connection efficiency. FIGS. 4c-4d show a two-step process, in which the fixing element 220 first receives a downward force and then a forward force. It may be understood that, in some other embodiments, FIGS. 4c-4d may be performed synchronously, that is, the fixing element 220 may receive a down oblique force to move directly from its initial state position into the passage.

As shown in FIG. 4e, the fixing element 220 is fully inserted into the main body 210 and the connector assembly 20 is assembled. In this state, the convex portion 2221 of the side plate 222 is inserted into the concave portion 215 of the side surface of the main body 210 to increase the connection stability of the connector assembly 20.

As shown in FIG. 4f, it can be seen that one conductive terminal 230 has been inserted into one cavity 211a, 211b, or 211c. Here, it can be seen that the interior of the cavity 211a, 211b, or 211c includes a stepped locking portion 2111 for inserting and connecting the conductive terminal 230. In addition, as shown in FIG. 4a, the inserting portion 231 of the conductive terminal 230 includes a protruding notch 2311 for contacting with the locking portion 2111. After the one conductive terminal 230 is inserted into the cavity 211a, 211b, or 211c, the protruding notch 2311 is engaged with the locking portion 2111 to form a locking mechanism P between the one conductive terminal 230 and the cavity 211a, 211b, or 211c.

In some examples, the width of the opening 212 may span the width of the cavity 211a, 211b, or 211c. When the one conductive terminal 230 is accommodated in the cavity 211a, 211b, or 211c, the inserting plate 223 would abut against a portion of the one conductive terminal 230, where the width of the inserting plate 223 is close to the width of the opening 212. For example, as shown in FIG. 4f, when the inserting plate 223 of the fixing element 220 is inserted into the main body 210, the inserting plate 223 abuts against the edge of the inserting portion 231 to provide a secondary holding force between the one conductive terminal 230 and the cavity 211a, 211b, or 211c. In addition, assuming that the one conductive terminal 230 is not entirely inserted into the cavity 211a, 211b, or 211c, that is, the one conductive terminal 230 is located in the cavity 211a, 211b, or 211c but the protruding notch 2311 is not engaged with the locking portion 2111, when the inserting plate 223 is inserted into the opening 212, the inserting plate 223 will push the inserting portion 231 of the one conductive terminal 230 forward to its supposed position. Therefore, the inserting plate 223 can prevent an incomplete connection between the one conductive terminal 230 and the cavity 211a, 211b, or 211c.

In the connector housing 200 or 300 provided by the present disclosure, the main body accommodates the conductive terminal, and the fixing element is used to fix the conductive terminal. In addition, in an initial state, a detachable connecting element bridges the main body and the fixing element, resulting in the main body and the fixing element being structurally integrated. Therefore, only one set of mold is required to manufacture the connector housing 200 or 300, thereby simplifying the preparation process. In addition, the insertion process of the conductive terminal and the fixing process of the fixing element are performed on different sides of the main body, which facilitates the automated assembly of the connector assembly. Thus, the connector assembly 20 having the connector housing 200 or 300 reduces the complexity of molding and realizes automated assembly.

A method 500 of assembling the connector assembly 20 will now be described with reference to FIG. 5. The method 500 includes a step 501, a step 502, and a step 503. Although the method 500 will be mainly described with reference to the connector assembly 20 having the connector housing 200, the method 500 will also be described according to the connector assembly 20 having the connector housing 300 when the method 500 would differ based on which connector housing 200,300 is part of the connector assembly 20.

In the step 501, as shown in FIG. 5, the one or more conductive terminals 230 are inserted into the one or more cavities 211a,211b,211c, respectively, where the one or more conductive terminals 230 clamp respective cables. As shown in FIGS. 4a-4b, one conductive terminal 230 is inserted into one of the cavities 211a,211b,211c of the connector housing 200 to form a preliminary connection.

In the step 502, the fixing element 220 is pressed. The fixing element 220 is located on the top of the main body 210 and may be pressed. The direction of force applied to the fixing element 220 depends on the relative position of the fixing element 220 and the main body 210. The fixing element 220 of the connector housing 200 is pressed downward (that is, in a direction toward the main body 210) and forward (that is, in an insertion direction of the conductive terminal 230). The fixing element 320 of the connector housing 300 is pressed downward only. In some embodiments, the fixing element 220 or 320 may be pressed manually. In some other embodiments, the fixing element 220 or 320 may be pressed by a manipulator.

In the step 503, one or more inserting plates 223 are inserted into one or more openings 212 when the connecting element 224 is broken.

When the connecting element 224 between the side plate 222 and the main body 210 receives a certain force, the connecting element 224 is broken. After the connecting element 224 is broken, the fixing element 220 may continue to be pressed so that the inserting plate 223 is inserted into the opening 212. In this way, the assembly of the connector assembly 20 is completed.

It should be noted that the above embodiments are only exemplary embodiments of the present disclosure, and obviously, the present disclosure is not limited to the above embodiments, and there are many similar changes. All variations directly derived or associated from the disclosure of the present disclosure by those skilled in the art shall fall within the protection scope of the present disclosure.

1. A connector housing, comprising:
a main body including one or more cavities accommodating one or more conductive terminals, one or more openings are provided on one surface of the one or more cavities; and
a fixing element located on one side of the main body, the one side of the main body has the one or more openings, the fixing element includes a top plate, two side plates, one or more inserting plates, and a connecting element, the two side plates are each bent from the top plate and extend toward two opposite sides of the main body, the one or more inserting plates are bent from the top plate and extend toward the main body, each inserting plate is inserted into one of the one or more openings when the fixing element receives a certain force, the connecting element is between the two side plates and the main body, the connecting element is broken when the fixing element receives the certain force.

2. The connector housing of claim 1, wherein each inserting plate is offset from one of the one or more openings on the one surface of the one or more cavities, and each inserting plate is offset from each corresponding opening by an equal distance.

3. The connector housing of claim 1, wherein each inserting plate is disposed opposite to one of the one or more openings on the one surface of the one or more cavities.

4. The connector housing of claim 1, wherein the two opposite sides of the main body have a plurality of guiding portions, each guiding portion guides one of the two side plates to move such that the one or more inserting plates are inserted into the one or more openings.

5. The connector housing of claim 4, wherein each guiding portion includes a support block, each support block is below the one of the two side plates and spaced apart from the one of the two side plates.

6. The connector housing of claim 5, wherein a ramp is provided at a junction of a top side of each support block and a front side of each support block.

7. The connector housing of claim 5, wherein a first distance between the one or more inserting plates and the one surface of the one or more cavities is greater than a second distance between the two side plates and the support blocks.

8. The connector housing of claim 4, wherein each guiding portion includes a blocking block, each blocking block blocks excessive movement of the two side plates in a forward direction and guides the two side plates to move downward.

9. The connector housing of claim 1, wherein a side surface of the main body has a concave portion, and an inner side of one of the two side plates has a convex portion, the convex portion is inserted into the concave portion when each inserting plate is inserted into one of the one or more openings.

10. The connector housing of claim 1, wherein the connecting element forms a connecting bridge between the main body and the fixing element to connect the main body to the fixing element, and when the fixing element receives the certain force, the connecting bridge of the connecting element is broken such that the fixing element moves toward the main body.

11. The connector housing of claim 1, wherein the one or more cavities of the main body include a first cavity, a second cavity, and a third cavity arranged in parallel in sequence, the second cavity is staggered with respect to the first cavity and the third cavity.

12. The connector housing of claim 11, wherein the top plate has a through hole, a position of the through hole is opposite the opening on the second cavity.

13. The connector housing of claim 1, wherein a bottom of the main body has a plurality of separating elements extending downwardly and separating the connector housing from an external device.

14. The connector housing of claim 1, wherein a bottom of each of the one or more cavities has a socket, a position of the socket is adjacent to an insertion position of a respective conductive terminal of the one or more conductive terminals.

15. The connector housing of claim 1, wherein an interior of each of the one or more cavities includes a locking portion for inserting and connecting a respective conductive terminal of the one or more conductive terminals, the locking portion is stepped.

16. A connector assembly, comprising:
a connector housing including a main body and a fixing element located on one side of the main body, the main body includes one or more cavities, one or more openings are provided on one surface of the one or more cavities, the one side of the main body has the one or more openings, the fixing element includes a top plate, two side plates, one or more inserting plates, and a connecting element, the two side plates are each bent from the top plate and extend toward two opposite sides of the main body, the one or more inserting plates are bent from the top plate and extend toward the main body, each inserting plate is inserted into one of the one or more openings when the fixing element receives a certain force, the connecting element is between the two side plates and the main body, the connecting element is broken when the fixing element receives the certain force; and
one or more conductive terminals, each of the one or more conductive terminals includes an inserting portion and a cable connecting portion, the inserting portion is inserted and connected with each of the one or more cavities, and the cable connecting portion clamps a cable.

17. The connector assembly of claim 16, wherein two opposite sides of the inserting portion include a protruding notch contacting a locking portion.

18. A method, comprising:
providing a connector assembly including a connector housing and one or more conductive terminals, the connector housing including a main body and a fixing element located on one side of the main body, the main body includes one or more cavities, one or more openings are provided on one surface of the one or more cavities, the one side of the main body has the one or more openings, the fixing element includes a top plate, two side plates, one or more inserting plates, and a connecting element, the two side plates are each bent from the top plate and extend toward two opposite sides of the main body, the one or more inserting plates are bent from the top plate and extend toward the main body, each inserting plate is inserted into one of the one or more openings when the fixing element receives a certain force, the connecting element is between the two side plates and the main body, and each of the one or more conductive terminals includes an inserting portion and a cable connecting portion;
inserting the one or more conductive terminals into the one or more cavities, respectively, the one or more conductive terminals each clamp one respective cable;
pressing the fixing element to break the connecting element; and
inserting the one or more inserting plates into the one or more openings when the connecting element is broken.

19. The method of claim 18, wherein pressing the fixing element includes pressing the fixing element in a direction toward the main body.

20. The method of claim 19, wherein pressing the fixing element includes pressing the fixing element along an insertion direction of the one or more conductive terminals.
